(19) United States
(12) Patent Application Publication
(10) Pub. No.: US 2010/0220545 A1
(43) Pub. Date: Sep. 2, 2010

(54) MIXER AND METHOD OF MIXING

(75) Inventor: Chris Brown, Glossop (GB)

Correspondence Address: MICHAEL BEST & FRIEDRICH LLP, 100 E WISCONSIN AVENUE, Suite 3300, MILWAUKEE, WI, 53202, US

(73) Assignee: MAELSTROM ADVANCED PROCESS TECHNOLOGIES LTD, Glossop (UK)

(21) Appl. No.: 11/994,174

(22) PCT Filed: Jun. 29, 2006
(86) PCT No.: PCT/GB06/02417

§ 371 Date: Dec. 28, 2007

(30) Foreign Application Priority Data
Jun. 29, 2005 (GB) 0513456.4

(51) Int. Cl. B01F 7/00; B01F 15/06; B01F 5/12

(52) U.S. Cl. 366/132; 366/293; 366/131; 366/144; 366/147; 366/192; 366/294; 366/134; 366/177.1; 366/262

(57) ABSTRACT

A dynamic mixer in which two members (1,2) are rotated relative to each other about a predetermined axis (XX), the members having facing surfaces (15, 16) which extend axially and between which is defined a mixing chamber through which a flow path extends between an inlet (7) for material to be mixed and an outlet (8). An array of two or more mixing formations is defined on at least one of the facing surfaces (15, 16) which extend radially towards the facing surface of the other element (15, 16) and which act to mix material within the mixing chamber, and which extend axially generally parallel to the axis. A mixing formation thus defined is configured to provide a constricting flow passage followed by an expanding flow passage to material present in the mixing chamber as the first and second members are relatively rotated, with the mixing formations located around the axis on any plane perpendicular to the axis so as to provide a generally net balance of the radial loads imparted by material present in the space between the surfaces. The material within the mixing chamber is subjected to high extensional and or shear stresses arising from the circumferential drag flow induced between the closely separated facing surfaces, while being permitted to flow axially between the widely separated flowing surfaces. Dispersive mixing and distributive mixing effects are thereby obtained.

The present invention relates to mixing and provides a new mixing apparatus and mixing method. In particular, the present invention relates to high energy mixing of viscous materials. It will be understood that the term “mixing” includes the processing of single materials.

The operation of mixing is generally understood to comprise two distinct actions: dispersive mixing and distributive mixing. In dispersive mixing the individual parts of the materials being mixed, whether solid or fluid, have their respective geometries altered by means of applied stresses. This usually takes the form of reducing the average size of individual parts while increasing their numbers. In distributive mixing the individual parts of the materials, whether solid or fluid, are blended together in order to obtain a spatial uniformity in the distribution of the various material parts with respect to one another. A good mixing operation thus generally requires both dispersive and distributive mixing actions to occur.

Mixing of high viscosity materials such as polymers is conventionally achieved as either a batch or a continuous process. In a batch process such as that used for polymer compounding, the process is generally designed to maximise the amount of distributive mixing that takes place, typically for the purpose of ensuring that multiple ingredients are satisfactorily blended together. The ability of such batch machines to perform high stress dispersive mixing is compromised by this distributive mixing requirement. Typical machines used in this regard are the internal mixer for polymers and the bead mills and saw-tooth dispersers used for mixing materials such as paints and adhesives.

A less common type of machine used for batch mixing of highly viscous fluids is the open two-roll mill, where levels of dispersive mixing are higher than those of internal mixers. The two-roll mill applies relatively high levels of stress to the material passing through a narrow gap between the two parallel rolls, although the amount of stress that can be applied in this manner is limited by the mechanical strength of the machine in withstanding the severe separating forces that are generated between the rolls. Furthermore, the efficiency of distributive mixing by the two-roll mill is limited by the need for significant manipulation (usually manual) of the material to cause it to repeatedly enter the roll gap and to move it along the axial length of the rolls.

The same limitations on dispersive and distributive mixing capabilities apply to machines such as calenders that comprise more than one set of parallel rolls. In this regard it may be noted that the batch internal mixer can be considered to be an enclosed form of two-roll mill in which the material passing through the gap between the rolls is recirculated within the machine to re-enter the gap without further intervention. While this action provides an improvement over the two-roll mill terms of distributive mixing efficiency, the gap between the rolls of an internal mixer are larger than those of a two-roll mill for reasons of strength and efficiency as well as the need to accommodate the geometrical features that promote distributive flow, and the dispersive mixing capability of the mixer is consequently inferior to that of the mill.

The mixing of high viscosity materials in a continuous process is generally achieved by means of a high distribution but low dispersion device such as a static mixer or an agitated chamber within a process line, or by means of an extruder. Such extruders generally take the form of single-screw extruders, which are inherently better dispersive mixers than they are distributive mixers, and twin screw extruders, which are able to achieve greater distributive mixing effects than their single screw counterpart, but are inherently limited by the screw separation forces in the amount of dispersive stress that they can apply to materials being processed. In this regard, the single-screw extruder can be considered to be a device that contains a design compromise between the functions of pumping, heating and mixing, with the mixing function being primarily concerned with achieving a sufficiently even distribution of material throughout the annular cross-section of the machine. Because the single screw extruder is not a positive displacement pump, its ability to pressurise material is limited and it is therefore limited in its ability to propel material axially through multiple high shear zones in order to achieve significant levels of dispersive mixing. Furthermore, single screw extruders in themselves do not impart high shear stresses to all the material contained within the screw. However, extruders may be equipped with mixing sections which usually contain one or more flights of limited length in order to impart shear stresses to the material. However, in such mixing elements the amount of shear energy that can be applied is limited.

In a similar manner to the single screw extruder, the twin-screw extruder, whether co-rotating or counter-rotating, is not a positive displacement pump and suffers the same limitations in pumping. Unlike the single screw extruder, the twin-screw extruder does provide for active distributive mixing of materials by virtue of the interactions between the formations of the two screws. The ability of the twin screw extruder to apply relatively high levels of dispersive stress is limited by similar considerations to those applying to two-roll mills and described above, namely that the rotatable elements are subjected to out-of balance forces that arise from the interactions between themselves, and to which must be added the net axial forces that are applied to the screws and their drive system. In other respects such as the proportion of time spent by material in the low stress zones of the extruder screw, the twin screw extruder suffers similar limitations to those of the single screw extruder.

Of the types of machinery commonly used in mixing high viscosity materials, it may therefore be seen that their designs are unsuited to efficiently applying very high levels of stress and energy to highly viscous materials for maximising dispersive mixing, while simultaneously achieving an acceptable level of distributive mixing. It is an object of the present invention to provide a mixer that can achieve such mixing, whether as a continuous process or as a batch process.

According to a first aspect of the present invention there is provided an elongate annular mixing chamber defined around a longitudinal axis and having a radial width defined between facing surfaces of a first elongate mixing member disposed axially within a second tubular mixing member;

the first and second mixing members being relatively rotatable;

an inlet for introducing material to be mixed into the mixing chamber, and an outlet for removing material from the mixing chamber.

wherein for any given rotational position of the first and second mixing members the radial width of at least one axially extending portion of the mixing chamber varies around the axis to define at least one radial constriction;

the radial constriction extending along the length of said portion of the mixing chamber in a direction subtending an angle no greater than 45° to any plane containing said axis.

The apparatus according to the present invention forces material within the mixing chamber to repeatedly flow through the radial constriction imparting high shear stresses on the material.

The apparatus preferably includes a pump to pump material in to and out of the chamber. For instance in preferred embodiments the inlet is located adjacent one end of the chamber and the outlet is located adjacent the other end of the chamber and the pump is provided to pump material through the chamber in a continuous process.

The or each radial constriction provides a relatively high stress zone for the promotion of substantially circumferential extensional and/or circumferential shear flow as material flows through said constriction as a result of the relative rotation of the first and second mixing members. Between successive passages through the high stress zone, material within the mixing chamber will flow through a non-constricted (i.e. relatively large width) zone providing a relatively low stress region. The geometry of the mixing chamber is preferably such that material will not stagnate within the low stress regions.

The present invention thus provides a dynamic mixing apparatus with a mixing chamber configured to present material within the mixing chamber with a sequence of constricting and expanding flow passages through which the material flows as the mixing members are relatively rotated. Material within the mixing chambers is thereby subjected to extensional and/or shear stresses arising from the circumferential drag flow of material through the or each radial constriction. In a continuous mixing process, material within the mixing chamber is subjected to the blending of the axial and circumferential flows arising from their respective flow patterns.

Ensuring that the radial constriction extends along a line no greater than 45° to any plane containing the longitudinal axis of the mixing apparatus ensures that no significant pumping force is generated by the relative rotation of the mixing members. This is distinguished for instance from a screw extruder in which the extruder flight is much more steeply angled with respect to the axis of rotation in order to generate the required pumping force.

Preferably for any cross-section through the mixing chamber on a plane normal to the axis the or each radial constriction has a radial width, the ratio of said radial width to the minimum internal diameter of the second tubular mixing member at that cross-section being at least 0.05 or on average at least 0.05 along the length of said portion of the mixing chamber.

For instance, on the case of a single screw extruder, the extrusion process requires that only a small portion of material may enter the gap between the extremity of the screw flight and the internal surface of the barrel. Accordingly, this gap is minimised to maximise pumping efficiency and to ensure that material within the extruder remains within the screw channel as it passes from the inlet to the outlet of the extruder. Accordingly, no significant volume of material flows circumferentially past the flight and thus there is no significant high shear working of the material within the extruder.

The or each radial constriction extends along the length of said portion of the mixing chamber in a direction substantially parallel to said longitudinal axis.

The portion of the mixing chamber may comprise the whole length of the mixing chamber defined between the inlet and the outlet.

Typically the length of the mixing chamber will be at least three times its minimum diameter, and more usually greater than five times its minimum diameter. In some embodiments the length of the mixing chamber may be ten or more times the minimum diameter of the chamber.

Preferably there are at least two of said radial constrictions angularly disposed around the mixing chamber so that for any rotational position of the mixing members radial forces on the mixing members are balanced so that the net force in any radial direction is substantially zero.

These may for instance be only two of said radial constrictions defined so that for any rotational position of the mixing members a first radial constriction is diametrically opposed to a second radial constriction. Alternatively these may be more than two radial constrictions defined so that the mixing chamber has rotational symmetry about said axis.

In some embodiments the internal surface of the second tubular mixing member may have a substantially circular profile along the length of said portion of the mixing chamber, and the outer surface of the first mixing member may have a non-circular profile along the length of said portion to thereby define at least in part the or each radial constriction.

In some embodiments the inner surface of the second tubular mixing member may have non-circular profile along the length of said portion of the mixing chamber to define at least in part the or each radial constriction.

The present invention also provides a method of mixing, providing a mixing apparatus comprising:

an elongate annular mixing chamber defined around a longitudinal axis and having a radial width defined between facing surfaces of a first elongate mixing member disposed axially within a second tubular mixing member;

the first and second mixing members being relatively rotatable;

an inlet for introducing material to be mixed into the mixing chamber, and an outlet for removing material from the mixing chamber.

wherein for any given rotational position of the first and second mixing members the radial width of at least one axially extending portion of the mixing chamber varies around the axis to define at least one radial constriction;

the radial constriction extending along the length of said portion of the mixing chamber in a direction subtending an angle no greater than 45° to any plane containing said axis;

the method comprising:

pumping material to be mixed through said chamber via said inlet and outlet;

and relatively rotating said first and second mixing members to cause all material in said mixing chamber to flow through the or each radial restriction a plurality of times.

The facing surfaces of the two mixing members may extend axially at some angle or angles to the axis of rotation and thereby produce a change in the radial distance between the facing surfaces as a result of a relative axial displacement of the members. Such an arrangement of tapered surfaces may allow for the axial extraction of an inner cylindrical from a monolithic outer cylindrical member where applicable, although alternative geometries that would give rise to such axial interferences could otherwise be accommodated through the segmentation of an outer cylindrical member along at least one axial plane. With an arrangement involving members that taper in the manner described above, a means of axially displacing one member relative to the other may be provided. Such means may comprise, for instance, a set of external mountings that enable an outer member to be located at various axial positions relative to an axially fixed inner member, a mechanism to enable an inner member to be located at various axial positions relative to an axially fixed outer member, or some combination of the two. Furthermore, the means for adjusting the relative axial position of the two members may be operated while the apparatus is stationery or may be operated to adjust the position and hence the radial clearances while the apparatus is operating in production.

Preferably one or both of the mixing members contains means for cooling or heating the surface of the member and or the material within the mixing chamber. Such means may comprise a passage or passages through which cooling and or heating fluid is transported. Preferably said passages or chambers within a member will be located close to the wall facing the mixing chamber. Alternative means of heat transfer may be applied instead of heat transfer fluids, for instance electrical heating elements, heat pumps or externally mounted fans.

The mixing formations may preferably be defined by surfaces that, within a plane perpendicular to the axis of rotation, act on the material within the mixing chamber so as to produce a set of reaction forces on each of the two mixing members, whereby the sum total of the radial components of the vectored forces so produced is zero or otherwise of a value that is sufficiently small as to prevent damage to the facing surfaces of the apparatus. Said mixing formations may be defined by surfaces that, within a plane perpendicular to the axis of rotation, are rotationally symmetrical and or mirror symmetrical about the axis of rotation. Alternatively, mixing formations may be defined that, while not geometrically symmetrical, do provide the said set of radially balanced reaction forces. Some embodiments of the invention may comprise a single type of mixing formation, whether geometrically symmetrical or unsymmetrical. Other embodiments of the invention may comprise two or more types of mixing formation, geometrically symmetrical and or unsymmetrical, axially displaced one from the other so as to achieve differing mixing actions on material as it passes through the length of the apparatus.

The mixing formations may be defined to act on the material within the mixing chamber in a manner that is independent of the direction of the relative rotation of the mixing members with respect to each other. Such action will produce stress and flow behaviour in the material when the mixing members are relatively rotated in a first direction that differs from the stress and flow behaviour produced when said members are relatively rotated in an opposite second direction.

Preferably the generally annular space formed between the surfaces of the members is fully occupied by material during the mixing operation. The material to be mixed may be presented under pressure to the inlet of the apparatus by a pumping and pressurising means that is driven either independently of, or co-dependently with, the apparatus. In a first preferred embodiment of the invention the means of delivering the material to the apparatus is an independently driven extruder or positive displacement pump. In a second preferred embodiment of the invention the means of delivering the material to the apparatus is an extruder directly connected to the inlet, whereby the outer barrel of the extruder is coupled to the external member of the apparatus and the inner screw of the extruder is coupled to the internal member of the apparatus and rotatably driven with it. Alternative methods of coupling and driving such an arrangement are possible.

To regulate the flow rate and pressure of the material in conjunction with its propulsion a means of applying a back-pressure to the apparatus may be attached to the outlet. Such means may for instance be a die, valve or similar restriction to flow and may provide fixed or variable flow and or pressure regulation.

Preferably the apparatus according to the present invention may incorporate means to drive one or both mixing members with a relative rotatable motion. The speed of the relative rotation may be varied, intermittently or periodically, to apply varying levels of dispersive mixing power to the material within the mixing chamber. The direction of the relative rotation may be reversed, intermittently or periodically, to apply differing mixing actions in terms of stresses and or flow patterns to the material within the mixing chamber.

The mixing apparatus may contain means to add material to the mixing chamber at one or more locations other than the inlet to the chamber. Such entrances may be located at one or more positions along the axial length or around the radial boundary of the apparatus. The addition of materials at said intermediate locations will preferably be achieved at a supply pressure greater than or equal to that existing within the mixing chamber at the point of entry.

By regulating the rotational speed of the apparatus, the mixing power applied to the material within the mixing chamber may be controlled at any instant. By separately regulating the rotational speed of the apparatus and the flow rate of material though the mixing chamber, the net amount of mixing energy applied per unit volume of the material may be controlled for any particular material requirement. The speed and direction of rotation of the apparatus may be intermittently or periodically varied during operation to obtain the desired mixing effect within the mixing chamber. The flow rate through the machine may typically be regulated by varying the pumping pressure and or rate of the material supplied to the chamber, by varying the outlet conditions of the apparatus, or by some combination of these. The amount of mixing energy applied to material within the chamber may be regulated by varying the length of either or both mixing members and or by varying the radial separation distance between the mixing members.

Apparatus in accordance with the present invention may be used within continuous process operations and, where the mixing chamber is provided at its inlet with a continuous supply of material at the appropriate pressure, within batch process operations.

Apparatus in accordance with the present invention can be used to mix a single material (the term mixing in this context is used throughout the mixing industry referring to, for example, dispersive mixing of a material to break it down into smaller component parts which may be coupled with distributive mixing in distributing those smaller parts through the material as a whole) or a number of different materials including mixtures of fluids and solids, or indeed just solids which are capable of behaving in a manner analogous to fluids. The apparatus may be used to produce the stress and flow conditions required selectively to rupture crosslinks while processing crosslinked material. Furthermore, the apparatus can be used to provide the physical conditions, including pressure, temperature, motion and size, that are required to promote chemical reactions within the mixing chamber.

Specific embodiments of the present invention will now be described, by way of example only, with reference to the accompanying drawings, in which:

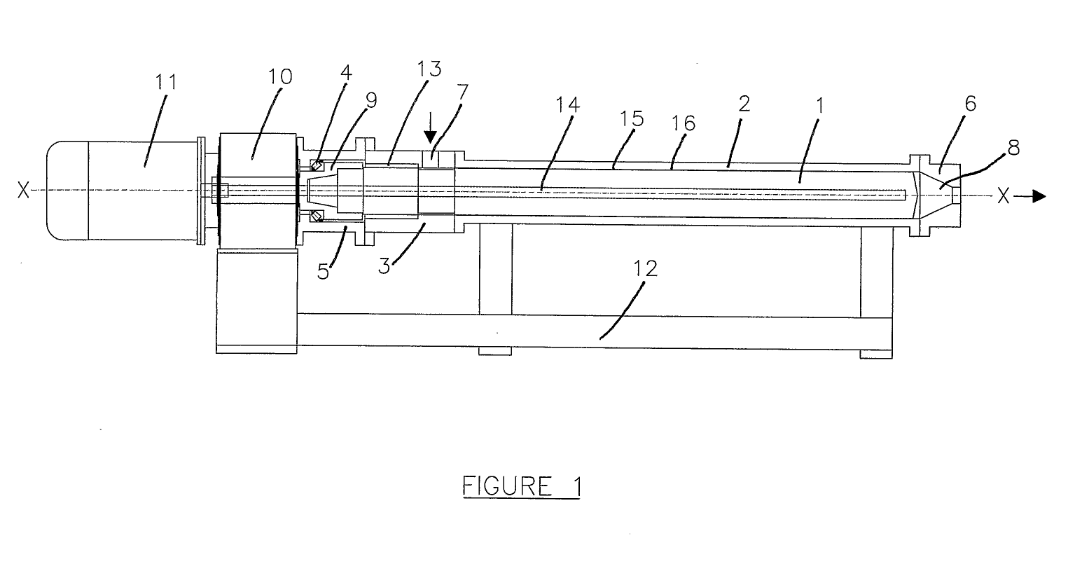

FIG. 1 is an axial section through a first embodiment of the present invention;

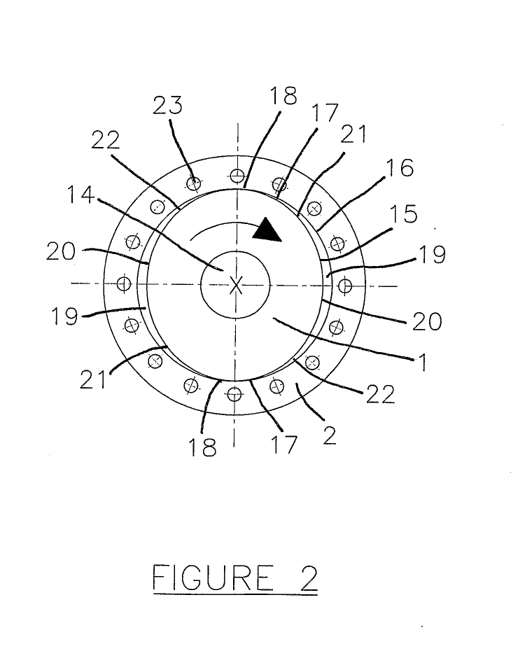

FIG. 2 is a sectional end-view of the embodiment of FIG. 1;

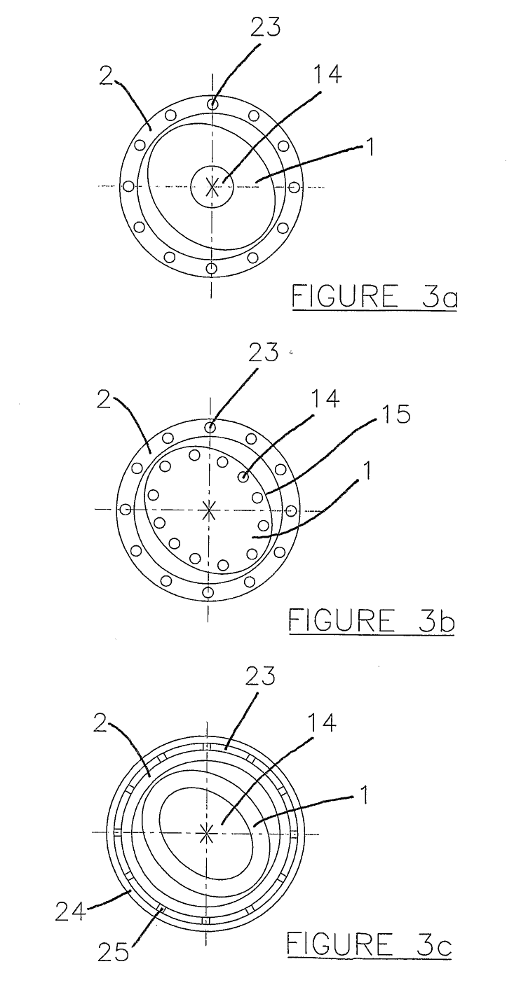

FIGS. 3a, 3b, 3c are sectioned end-views of the embodiment of FIG. 1 providing illustrations of various alternative types of cooling passages (not to scale);

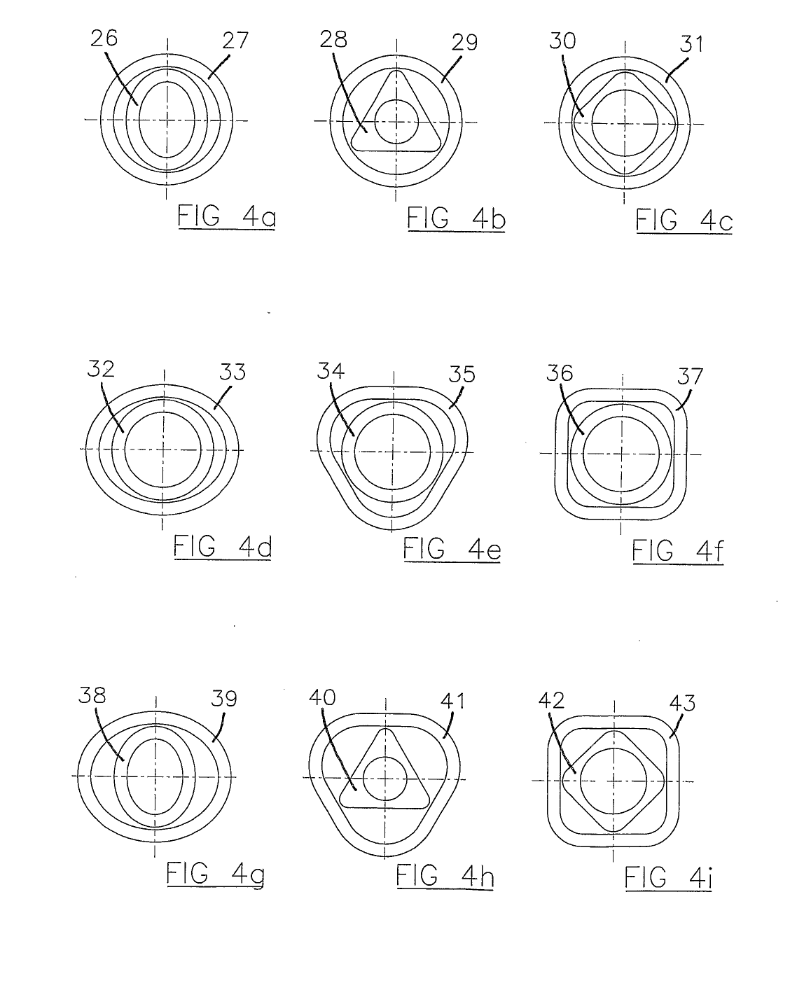

FIGS. 4a, 4b, 4c, 4d, 4e, 4f, 4g, 4h, 4i are sectioned end-views of the embodiment of FIG. 1 providing illustrations of various alternative types of member formations (not to scale);

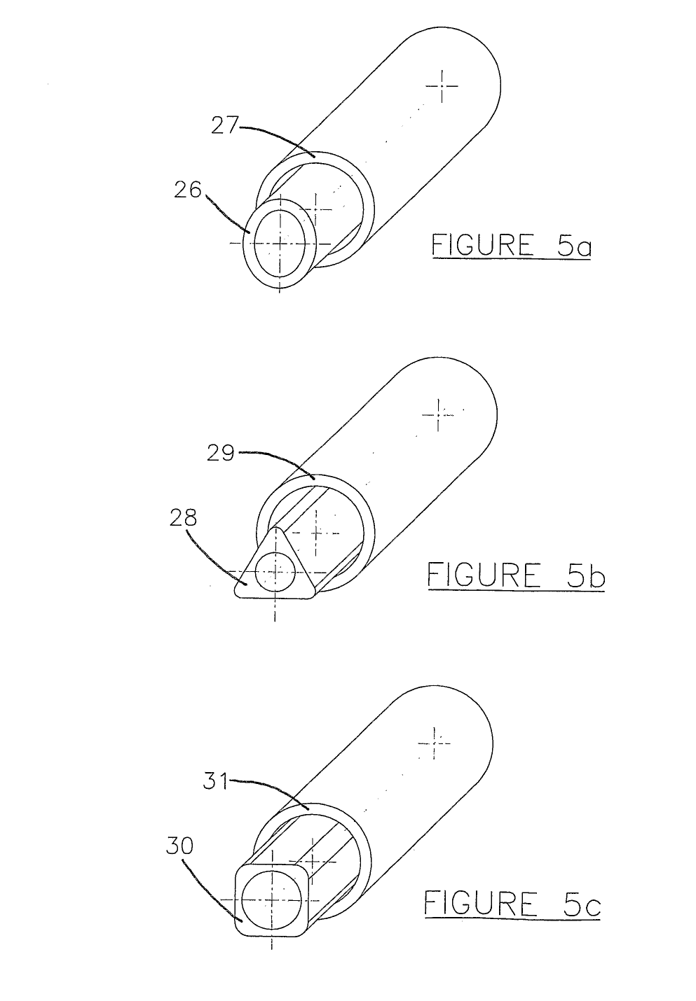

FIGS. 5a, 5b, 5c are part-sectioned isometric illustrations of the member formations corresponding to FIGS. 4a, 4b, 4c (not to scale);

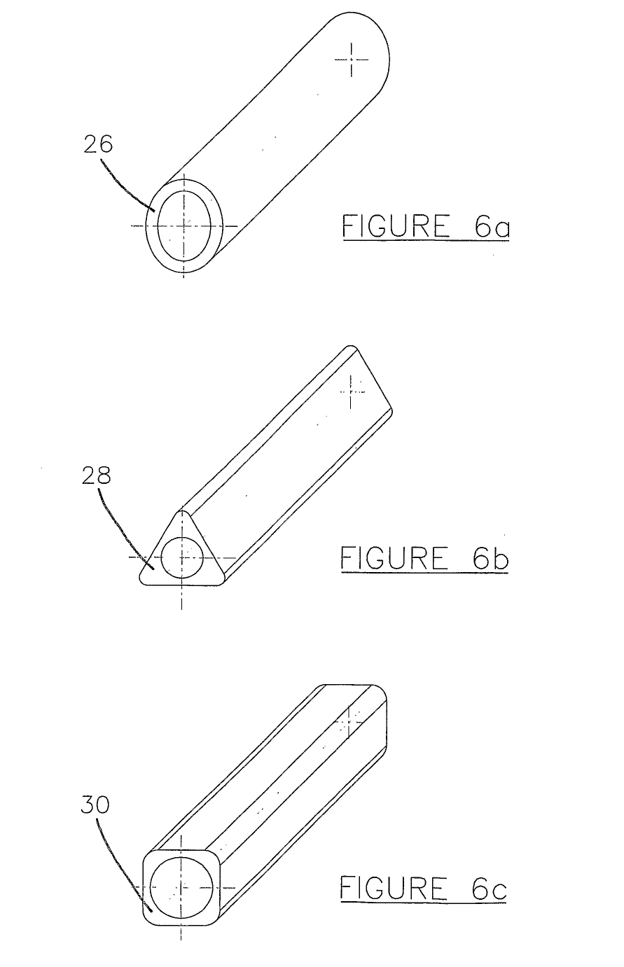

FIGS. 6a, 6b, 6c are isometric illustrations of the inner member formations corresponding to FIGS. 4a, 4b, 4c and FIGS. 5a, 5b, 5c (not to scale);

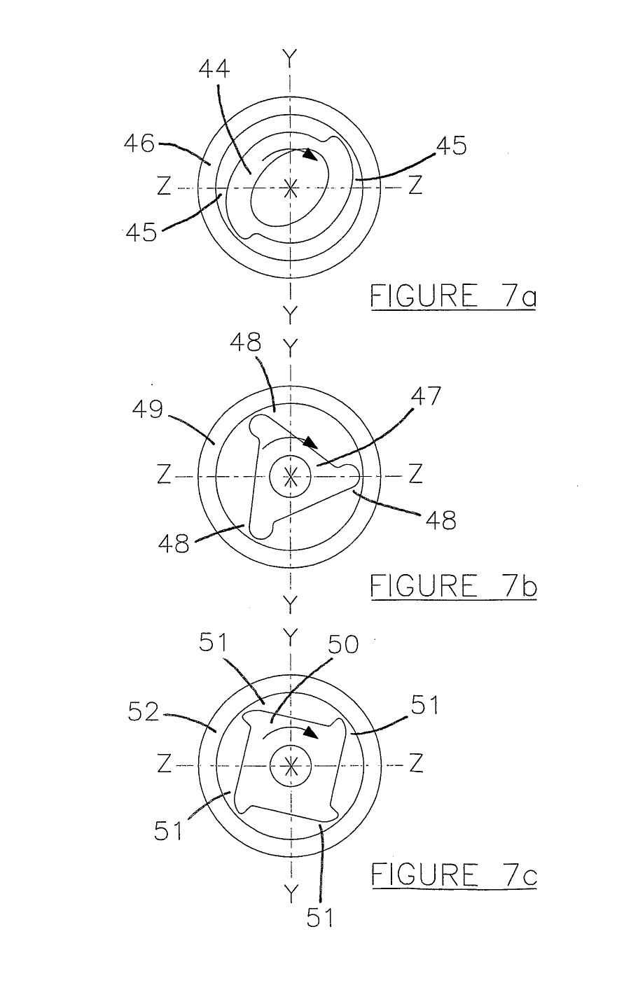

FIGS. 7a, 7b, 7c are sectioned end-views of the embodiment of FIG. 1 providing illustrations of various alternative types of member formations that are not mirror-symmetrical (not to scale);

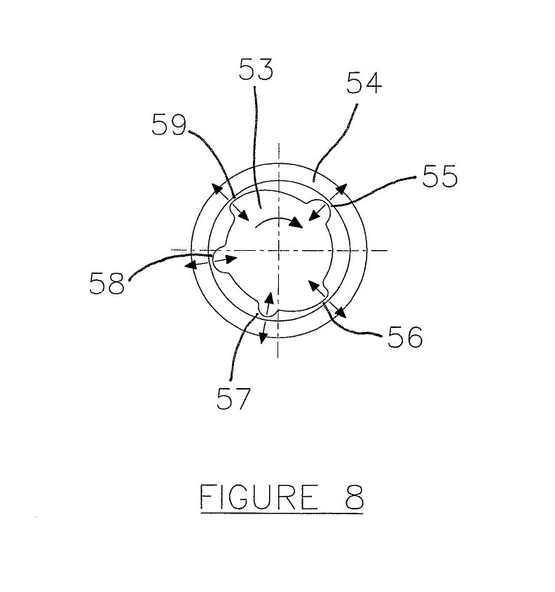

FIG. 8 is a sectioned end-view of the embodiment of FIG. 1 providing an illustration of a non-symmetric geometry (not to scale).

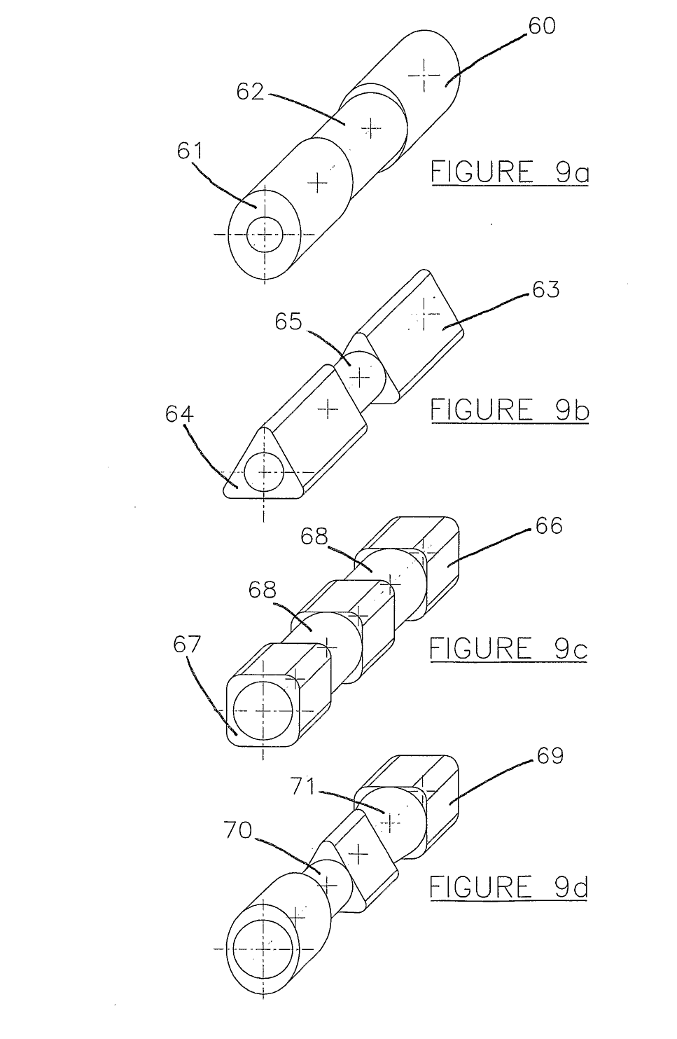

FIGS. 9a, 9b, 9c, 9d are isometric illustrations of various alternative configurations of rotor element in which the formations contain axial interruptions (not to scale);

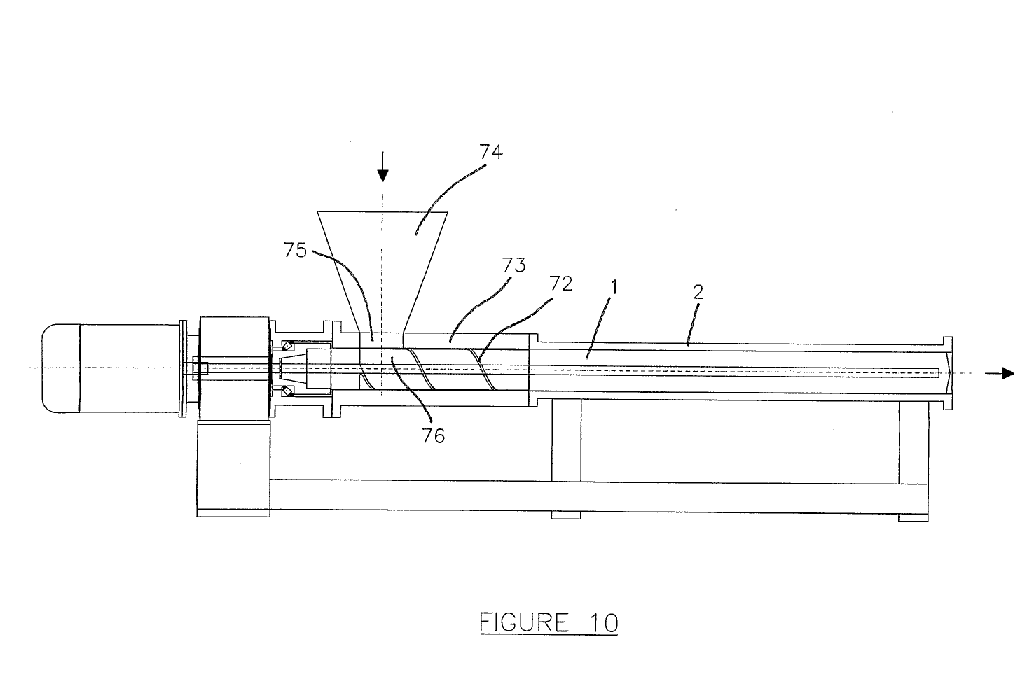

FIG. 10 is an axial section though a second embodiment of the present invention incorporating an extrusion screw as the means of material propulsion.

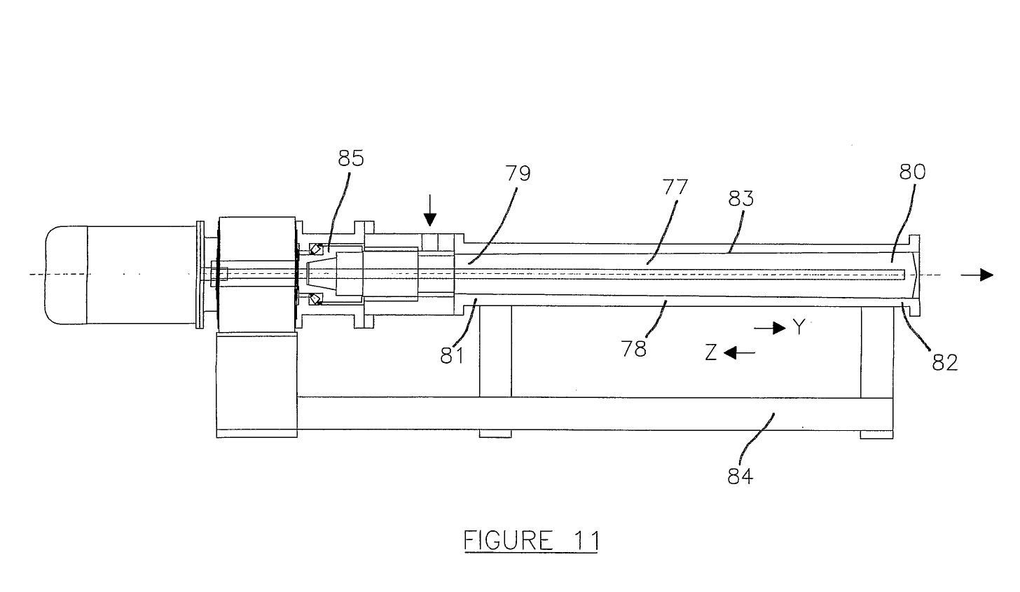

FIG. 11 is an axial section through a third embodiment of the present invention incorporating axially tapered elements.

It will be appreciated that terms such as “rotor”, “stator”, “mixer”, “mixing” and “coolant” are applied within this descriptive text for illustrative purposes only and are not to be understood as limiting definitions.

Referring to FIG. 1, the illustrated mixer comprises a rotor 1 (first mixing member) mounted within a stator housing 2 (second mixing member) and within an inlet housing 3, and supported in drive collar 9 which is supported within bearings 4 within a drive housing 5. Rotor 1 rotates about axis XX. Inlet housing 3 is attached to stator housing 2 and drive housing 5 is attached to inlet housing 3. Drive collar 9 is rotatably driven through gear reducer 10 by motor 11. The stator housing 2 and the gear reducer 10 are mounted on support frame 12. An outlet housing 6 is attached to the opposite end of the stator housing. The inlet housing 3 defines a mixer inlet 7 and the outlet housing 6 defines a mixer outlet 8. The material to be mixed is fed into the mixer inlet 7 by an externally mounted and driven pumping means (not shown) to which it is connected. An annular seal 13 prevents material from escaping axially in the direction of the drive collar 9, and the material to be mixed is thus pumped axially into the annular space between the rotor 1 and the stator 2. A heat transfer fluid channel 14 contained within rotor 1 serves to direct fluid, typically a coolant, down the length of the rotor. The external surface 15 of rotor 1 and or the internal surface 16 of stator 2 support projections and or indentations that extend axially over the lengths of rotor 1 and or stator 2 respectively.

It will be appreciated that the terms rotor and stator may be interchanged, for instance in an embodiment of the invention similar to that shown in FIG. 1 in which the outer mixing member is rotatably driven while the inner mixing member is fixedly supported. It will further be appreciated that yet another embodiment of the invention may comprise an apparatus in which both inner and outer mixing members are driven rotatably while maintaining some form of relative rotation between themselves.

Referring to FIG. 2, the end-view of mixing member 1 and mixing member 2 is shown in partial section. For purposes of illustration member 1 is shown to rotate about axis X in the direction shown while member 2 is fixedly mounted. The internal surface 16 of member 2 is defined as a circular surface of revolution equispaced from the axis X. The external surface 15 of member 1 comprises two diametrically opposite projections 17 locally extending the surface 15 radially outwards from axis X towards member 16 but separated from it by a radial gap 18 at its closest approach to the member 2 surface and by a radial gap 19 at its farthest distance from the member 2 surface. It will be appreciated that the external surface 15 of member 1 can alternatively be described as comprising two diametrically opposite indentations 20 extending radially inwards towards axis X from a radial gap 18 at its farthest extent 17 to a radial gap 19 at its closest extent 20.

The annular space thus formed between surface 15 and surface 16 is occupied by material during the mixing operation, with the material being propelled in the axial direction by some external pumping means. During rotation of member 1 material located within the region of the largest gap 19 will be subjected a combination of radial and tangential forces as the radial gap is decreased from gap 19 to gap 18. This effect arises from the tendency of the boundary surfaces of viscous materials to adhere to their boundary walls even under conditions of transverse stress when they are subjected to sufficiently high stresses normal to such surfaces. With respect to the direction of travel indicated by the arrow, the leading edge 21 of each projection is profiled to provide such a gradual application of the radial stresses required, thereby subjecting a portion of the material to shear and extensional stressing as it is forced circumferentially through the narrowing gap in what may be called the compression zone. The remaining portion of the material that does not enter the compression zone is meanwhile subjected to lesser shearing forces, arising from both the relative rotation of member 1 and member 2 and the axial pumped flow of the material, that result in a circulatory flow pattern within the relatively larger gap zone 19, with material movement having some combination of radial, tangential and axial velocity components. This action promotes distributive mixing.

The shear stress reaches its greatest level at the point where the radial gap is at its smallest, point 18, and then diminishes as the gap expands down the trailing edge 22 of the projection. With the reduction in radial stressing along the trailing edge 22, the adhesion of the material to the wall is reduced and the coherency of the material causes it to flow radially as well as circumferentially within the increasing gap of what may be called the decompression zone, thereby blending the previously highly stressed portion of the material with the portion of the material remaining within zone 19 and ensuring a redistribution of the material to be subjected to the next cycle of compression and decompression. It will be appreciated that this redistribution effect incorporates the material that is moved through the mixer axially, primarily through the relatively large gap zone 19, as a result of the externally applied pumping.

It will be appreciated that the references to axial flow and circumferential flow are relative terms and that the absolute flow path described by the material will tend to be helical about the axis of rotation as a consequence of the vector sum of the axial and circumferential velocity components.

It will furthermore be appreciated that the number of times that any one part of the material will be subjected to the passage through the gap that induces the high stress will depend on the length of the apparatus, the relative cross-sectional areas (on any plane perpendicular to the rotational axis) of the high and low stress zones, the speed of rotation and the flow rate at which the material is propelled through the apparatus. A preferred embodiment of the invention may typically impose more than one high stress cycle upon each part of the material moving from inlet to outlet. For instance, a polymer mixing process may involve each part of the material being subjected to 15 to 20 passes through the high stress cycle as it moves though the mixer.

The diametrically opposite relationship of the projections 17 within the embodiment shown ensures that the substantial radial forces that arise from the radial compression of the material within the narrowing annular gaps are generally balanced. This ensures that member 1 remains generally centrally located within member 2 and that the presence of material in the smallest gap zones 18 generally prevents the two facing surfaces 15 and 16 from coming into contact with one another.

A set of heat transfer fluid channels 23 contained within member 2 and extending axially over all or part of its length serve to direct fluid, typically coolant, down the length of member 2. These member 2 channels 23, together with member 1 channel or channels 14, serve to regulate the temperature of the material being mixed within the chamber, it being appreciated that the application of high mixing stresses to the material could otherwise result in high and potentially damaging temperatures being reached within the mixer. It will also be appreciated that the regulation of the temperature of the mixed material may serve to control its viscosity while being processed and thereby permit the processing variables such as shear rate, shear stress, extensional stress, extensional stress rate, power, energy and degree of mixedness (distributive mixing effect) to be controlled.

The shape and number of the heat transfer fluid channels contained within the first and or second mixing members may generally be determined from consideration of a number of criteria such as the economy of manufacture and the effect on the mechanical strength of the components, as well as the heat transfer requirements and characteristics of the configuration. By way of example, FIGS. 3a, 3b and 3c illustrate some alternative configurations of heat transfer passages that can be provided within the mixing members. FIG. 3a shows a single axial passage 14 of circular cross-section within member 1, together with a set of axial passages 23 of circular cross-section within member 2 that are equispaced about the axis X. FIG. 3b shows a set of axial passages 14 of circular cross section within member 1 that are equispaced at a constant depth from its surface 15, together with a set of axial passages 23 of circular cross-section within member 2 that are equispaced about the axis X. FIG. 3c shows a single axial passage 14 within the member 1 that is defined as an elliptical shape to match that of member 1, together with a set of axial passages 23 within member 2 that are formed in the presence of an external structural layer 24 and the members 25 that attach this layer to the outer surface of member 2. The configurations depicted in FIGS. 3a to 3c are by way of examples only and it will be appreciated that other design configurations are possible. For example, the number of channels provided in member 1 and or member 2 can range from none to any reasonable number, although at least one channel in each of member 1 and member 2 is to be preferred, and the combination and configuration of such channels 14 and or 23 can take any number of forms.

In considering FIG. 2 it will be appreciated that the selection of the profiles of the projections 17 and or the indentations 20 as well as the size of the radial gaps 18 and 19 affect the amount of dispersive mixing stressing and the amount of distributive mixing applied to the material being processed. It will furthermore be appreciated that the number of projections and or indentations defined on the facing surfaces of the first and or second mixing member may be varied while maintaining a condition that the profile or profiles thus determined remain generally symmetrical around the axis so as to balance the radial loads generated. FIGS. 4, 5 and 6 illustrate some alternative designs of mixing member shapes.

FIG. 4a shows a design comprising a substantially elliptical mixing member 26 comprising two projections (or two indentations) contained within a circular mixing member 27. FIG. 5a shows a sectioned isometric view of this design and FIG. 6a shows an isometric view of member 26 alone.

FIG. 4b shows a design comprising a substantially triangular mixing member 28 comprising three projections (or three indentations) contained within a circular mixing member 29. FIG. 5b shows a sectioned isometric view of this design and FIG. 6b shows an isometric view of member 28 alone.

FIG. 4c shows a design comprising a substantially square mixing member 30 comprising four projections (or four indentations) contained within a circular mixing member 31. FIG. 5c shows a sectioned isometric view of this design and FIG. 6c shows an isometric view of member 30 alone.

FIG. 4d shows a design comprising a circular mixing member 32 contained within a substantially elliptical mixing member 33 comprising two indentations (or two projections). FIG. 4e shows a design comprising a circular mixing member 34 contained within a substantially triangular mixing member 35 comprising three indentations (or three projections). FIG. 4f shows a design comprising a circular mixing member 36 contained within a substantially square mixing member 37 comprising four indentations (or four projections).

FIG. 4g shows a design comprising a substantially elliptical mixing member 38 comprising two projections (or two indentations) contained within a substantially elliptical mixing member 39 comprising two indentations (or two projections). FIG. 4h shows a design comprising a substantially triangular mixing member 40 comprising three projections (or three indentations) contained within a substantially triangular mixing member 41 comprising three indentations (or three projections). FIG. 4i shows a design comprising a substantially square mixing member 42 comprising four projections (or four indentations) contained within a substantially square mixing member 43 comprising four indentations (or four projections).

The configurations depicted in FIGS. 4a to 4i, FIGS. 5a to 5c and FIGS. 6a to 6c are by way of examples only and it will be appreciated that other design configurations are possible. For example, the number of projections and or indentations of the first and or second mixing members may be extended indefinitely.

The radial balancing of net forces during the operation of the apparatus as depicted in FIGS. 4a to 4i, FIGS. 5a to 5c and FIGS. 6a to 6c may generally be derived through the presence of both rotational symmetry and reflective symmetry in the mixing members. Rotational symmetry is here defined as the ability of the planar shape to match itself on more than one occasion during one full rotation of 360 degrees around the primary axis (generally the rotational axis), and reflective symmetry is here defined as the ability of the planar shape to match itself at least once when rotated 180 degrees though some axis perpendicular to and intersecting with the primary axis. It will be appreciated that the balancing of net forces can also be obtained through other means, for example through the application of designs containing rotational symmetry but not reflective symmetry. Examples of some such designs containing rotational but not reflective symmetries are shown in FIGS. 7a to 7c. In FIG. 7a, mixing member 44 defines two sets of radial gaps 45 between itself and mixing member 46 that during operation of the mixer apply radial forces to the mixing members that are balanced. In FIG. 7b, mixing member 47 defines three sets of radial gaps 48 between itself and mixing member 49 that during operation of the mixer apply radial forces to the mixing members that are balanced. In FIG. 7c, mixing member 50 defines four sets of radial gaps 51 between itself and mixing member 52 that during operation of the mixer apply radial forces to the mixing members that are balanced. In each of the examples show in FIGS. 7a to 7c it will be seen that the inner mixing member displays rotational symmetry about axis X but that when it is rotated about an axis such as YY or ZZ, or any other axis in the same plane and intersecting axis X, it does not display reflective symmetry. The configurations depicted in FIGS. 7a to 7c are by way of examples only and it will be appreciated that other design configurations of first and or second mixing member are possible.

It will be further appreciated that the balancing of the net forces between first and second mixing members during mixing operations may be achieved by designs of mixing member shapes that do not display formal geometrical symmetry. An example of such a design is illustrated in FIG. 8, which shows member 53 with a geometry that is neither rotationally nor reflectively symmetrical, contained within a member 54 that is both rotationally and reflectively symmetrical. While the projections and indentations are arranged around the periphery of member 53 in a geometrically unsymmetrical fashion, it will be appreciated that an appropriate definition of the various gaps 55 to 59 can ensure that the stresses generated within those gaps during operation produce radial forces that are in balance and generally cancel one another. The configuration depicted in FIG. 8 is by way of example only and it will be appreciated that other design configurations of mixing members are possible for achieving the same result.

In the preferred embodiments of the invention the projections and indentations that are defined on the first and or second mixing member extend axially to some substantial extent. In FIGS. 5a to 5c and FIGS. 6a to 6c the projections are shown to extend over the full axial length of the mixer. It will be appreciated that alternative configurations are possible while satisfying a requirement for an axial extension. For instance, the projections and indentations may be interrupted at certain points along their axial lengths so as to promote distributive mixing, and or the configurations of projections and indentations may themselves vary over the or their axial length. Examples of configurations in which the projections and or indentations do not extend over the entire length of the mixer are provided in FIGS. 9a to 9d. FIG. 9a shows mixing member 60 in which the elliptical form of its projections 61 is removed for a part of its length 62. FIG. 9b shows mixing member 63 in which the triangular form of its projections 64 is removed for a part of its length 65. FIG. 9c shows mixing member 66 in which the square form of its projections 67 is removed for more than one part of its length 68. FIG. 9d shows mixing member 69 in which more than one form of projection and or indentation exists. In FIG. 9d the axial transitions 70 and 71 from one form of surface to another is shown as being abrupt; it will be appreciated that such transitions could be gradual. The configurations depicted in FIGS. 9a to 9d are by way of examples only and it will be appreciated that other design configurations of mixing members are possible.

In the preferred embodiments of the invention the projections and indentations that are defined on the first and or second mixing member extend axially and are generally parallel to the axis of rotation. It will be appreciated that the parallelity does not need to be precise in order to achieve the mixing action provided by this invention and that some angle between the projections and or indentations and the axis may provide some effects in advancing or retarding the flow of material through the mixer. However it is to be preferred that the geometry does not provide any substantial axial propulsion to the material, for example in the manner of an extruder. Such propulsion could negate the desired mixing effect and or could reduce the control thereof.

It will be appreciated that the rotation of apparatus according to the invention can be varied in speed and or direction. Variations in speed of rotation directly affect the amount of dispersive stress imparted to the material flowing through the high stress regions of the mixing chamber; in particular the mixing power imparted to the material is directly proportional to the speed of rotation. By increasing the rotational speed of the machine, the shear rate and hence shear stress and or the extensional rate and hence extensional stress are increased, while by decreasing the rotational speed the rates and stresses are reduced accordingly. For apparatus according to the invention that is supplied with material pressurised by external means such as an externally mounted and driven gearpump, the mixer rotational speed can be varied independently of the pumping speed and thus, for any given flow rate of materials passing though the mixer, the dispersive energy imparted to the material as the time-integral of the mixing power can be varied to provide the dispersive mixing effect required.

By changing the direction of relative rotation of the mixing members it will be appreciated that the interactions between the projections and or depressions and the material being stressed thereby may be significantly altered in those instances in which the apparatus does not present the same profile to the material in the one direction as it does in the other. For instance, while stresses arising in apparatus according to any of the configurations shown in FIGS. 4a to 4g is independent of the direction of relative rotation, other configurations according to the invention may provide stresses that differ from one direction of rotation to the other. For instance, in apparatus such as that shown in FIGS. 7a to 7c which, while still providing radially balanced loads, does not exhibit mirror symmetry, the flow patterns and hence the stresses that arise as material is acted upon by the mixing member surfaces differ according to the rotational direction. It will be appreciated that such an effect of changed flow patterns and stresses can have a practical application in mixing situations whereby for instance a temporary reversal of direction of rotation can be used to disrupt or otherwise alter flow patterns and thereby promote additional distributive mixing within the chamber, and or can be used to apply momentarily a different set of dispersive stresses to the material being mixed. In preferred embodiments of the invention, changes in the direction of rotation as described above may preferably be applied at regular intervals rather than irregular intervals to ensure that all material passing through the apparatus is subjected to substantially the same levels of dispersive and distributive mixing.

Referring to FIG. 10, the illustrated mixer comprises a mixer essentially identical to that embodied in FIG. 1 other than in respect of the arrangement for feeding the material to be processed. In the embodiment illustrated in FIG. 10, the rotor 1 is directly coupled to an extrusion screw 72 which is mounted within the inlet section 73. The drive arrangement for the extrusion screw replicates that of FIG. 1. Material to be processed is placed into hopper 74 from where it falls under the influence of gravity though opening 75 within the inlet section into the channels 76 of extruder screw 72. Rotating the extruder screw propels the material axially forward, into and through the annular gap between rotor 1 and stator 2. It will be appreciated that various modifications may be made to the extrusion section to improve its pumping performance, for instance inlet section 73 may be further modified on its internal surface by the addition of surface features such as grooves or undercuts, and or extrusion screw 72 may be provided with alternative forms and or numbers of screw flights thereon. The configuration depicted in FIG. 10 is by way of example only and it will be appreciated that other design configurations are possible.

Referring to FIG. 11, the illustrated mixer comprises a mixer similar to that embodied in FIG. 1 other than in respect of the tapered arrangement of the rotor 77 and stator 78. In this arrangement the rotor tapers from some smaller diameter at end 79 to some larger diameter at end 80, while the stator similarly tapers from some smaller diameter at end 81 to some larger diameter at end 82. The angle of taper of the rotor surface may or may not be similar to that of the stator surface. In this embodiment the external diameter of the rotor will preferably be smaller than the internal diameter of the stator, for instance at location 83 along its length, resulting in an annular gap between the two mixing members. It will be appreciated that, with stator 78 fixed axially in place with respect to frame 84, any adjustments made to the axial location of rotor 77, for instance by adjusting the length of the drive collar 85, will alter the dimension of the annular gap: typically, any movement of the rotor in direction Y will increase the radial gap, while any movement in direction Z will decrease the radial gap. The illustrated mixer thus provides, by way of example, a demonstration of how the geometry of the assembly may be varied in order to achieve changes in the mixing performance of the apparatus. It will be appreciated that a similar result may be obtained by means of an alternative arrangement of the illustrated apparatus in which the stator 78 is moved axially, for instance by relocating it on frame 84, while the rotor 77 remain axially fixed. It will also be appreciated that such variations in the relative axial positions may occur while the apparatus is static or while it is in operation, in which latter case the mixing action may be regulated in response to immediate operational requirements. The configuration depicted in FIG. 11 is by way of example only and it will be appreciated that other design configurations of apparatus are possible.

Referring to the embodiments shown in FIG. 1, FIG. 10 and FIG. 11, it will be appreciated that the axial lengths of the either or both of the rotor and stator members may be varied to change the net mixing effect of the apparatus. For instance, reducing the axial length of both mixing members, while maintaining a constant material throughput rate, will typically result in a lower total mixing energy being applied to the material as a consequence of it passing fewer times though the high stress zone as it moves from inlet to outlet, and or of it having a lesser residence time within the mixing chamber. Increasing the length of the mixing elements will typically have the converse effect. In some instances it will be appreciated that the length of only one element need be changed to have an effect, for instance the rotor may be shortened without necessarily requiring the stator to be similarly shortened. The alterations to the respective lengths of the mixing elements may be affected when the apparatus is stationary or during its operation. It will be appreciated that alterations to the lengths of the mixing elements while the apparatus is in operation may be achieved by axially moving one member with respect to the other in order to adjust the length of their mutual engagement or axial correspondence, for instance by moving the stator and or the rotor element in the embodiments depicted.

In general the mixing power and mixing energy applied to the material may be defined in terms of one or more of a number of geometrical and operational features of apparatus according to the invention. These features may for instance comprise: radial gap distances between mixing members, shapes of the surfaces of mixing members; lengths of circumferential path within the mixing chamber; length of axial path within the mixing chamber; flow rate of material though the mixing chamber; speed of relative rotation of the mixing members; temperature and heat transfer characteristics of the surfaces of the mixing chamber; rheology of the material or materials being processed.

It will be appreciated that some preferred embodiments of the present invention have the ability of the apparatus to apply and mechanically withstand extremely high stresses to the material by virtue of the balanced radial forces between the first and second mixing members. This ability enables apparatus to impose far higher dispersive mixing stresses through the close proximity of mixing surfaces than can be obtained in machinery representing the present state of the art, such as extruders, internal mixers and two-roll mills.

Another advantage of preferred embodiments of the present invention is the ability to apply cooling (and conversely heating) to the immediate vicinity of the mixing chamber in which material stresses and consequently temperatures are at their highest. This ability arises from the balanced nature of the loading on the machine which minimises the mechanical stresses such as bending stresses applied to the components; these relatively lower levels of stress in turn allow for a structure to be utilised that is lighter and therefore possesses a lower thermal inertia with higher heat transfer capability than conventional mixing machinery. Heat transfer may be further enhanced by the fact that the material is subjected to the maximum amount of stressing while it is passing though the narrowest gap between the surfaces and is thus at its minimum thickness. This proximity to the cooled internal walls of the machine ensures maximum heat transfer efficiency and effectiveness. In addition, smooth profiling of the internal surfaces of the mixing chamber facilitates the location of cooling passages in the immediate vicinity of the internal surfaces to promote such heat transfer.

Another advantage of preferred embodiment of the present invention is the capability of operating the material propulsion system independently from the material mixing system, for instance by using an externally driven pump to propel material through the mixer. It will be appreciated that, for any given geometry of the mixer, the dispersive mixing power applied to the material by the mixer is directly proportional to the rotational speed of the mixer and is essentially independent of the throughput rate through the mixer. However, while the dispersive mixing energy, which is the time integral of the dispersive mixing power, is directly proportional to the rotational speed of the mixer, the dispersive mixing energy per unit mass of the material is indirectly proportional to the throughput rate through the mixer. For instance, the lower the externally pumped flow rate through the mixer, the greater is the dispersive mixing energy per unit mass of material. Since the effectiveness of dispersive mixing relies on both the rate at which stress is applied (the power) as well as the total amount of stress applied (the energy), the apparatus according to the present invention is capable of imparting significantly higher dispersive energy levels to material than can current machines, such as extruders in which the pumping rate is in direct proportion to the mixing rate and in which, in consequence, any increase in speed and hence power is counteracted by an equivalent increase in pumping rate and a consequent inability to increase the mixing energy per unit mass of material. It will be appreciated that this ability to increase the amount of specific mixing energy to the material is furthermore enhanced by the effectiveness of the heat transfer provided by the invention, where the higher rates of cooling possible permit full advantage to be taken of the capability for operating at higher energy levels which might otherwise result in higher operating temperatures and consequently possible thermal damage to the material, and by the capability of increasing the axial length of the machine so as to increase residence time and hence the number of highly stressed cycles that the material is subjected to. It will also be appreciated that the converse applies in reducing the amount of energy applied to the material during mixing.

A further advantage of preferred embodiments of the present invention is the distributive mixing action that arises from the blending of highly stressed circumferentially moving material with the lowly stressed axially moving material. Not only does this action efficiently and effectively ensure that each part of the material passing though the mixer is subjected to approximately the same amount of high stress mixing as any other part, but that the material is maintained in physical and thermal homogeneity through the blending action induced by the respective flow patterns of highly and lowly stressed parts of the material.

Yet another advantage of preferred embodiments of the present invention is the relatively low pressure drop that arises across the length of the mixer as a result of the relatively large cross-sectional area of a part of the profile This large area enables material to be propelled through the apparatus with relatively little pumping power, while enabling the mixing power to be applied substantially independently in the form of rotational power. The pumping power requirements may in many instances be met by an extruder attached to the feed end of the mixer. Such an extruder may, where greater pumping pressures are required, be equipped with grooves or other such indentations within its barrel surface in the manner of conventional grooved-feed extruders or spirally-undercut extruders.

Embodiments of the present invention may enable performance levels to be achieved that are far higher than those of current state of the art mixers. This is of immediate relevance in terms of the rate and extent of particle size reduction (fluid and or solid) and the rate of blending, particularly in the processing of high viscosity materials.

The apparatus is extremely versatile and can be used in many different applications in all areas of mixing. For example, the apparatus can be used in all fluid to fluid mixing (preferably with at least one fluid being relatively viscous), fluid to solid mixing applications, and solid mixing applications (preferably with at least one solid exhibiting flow behaviour). The fluids may be liquids and gases delivered in single and multiple streams. The apparatus can be used for all dispersive and distributive mixing operations including emulsifying, homogenising, blending, incorporating, suspending, dissolving, heating, cooling, size reducing, wetting, hydrating, aerating, gasifying, solubilising, reacting and compounding, for example. The apparatus can be applied in either batch or continuous (in line) operations. Thus the apparatus could be used to replace conventional internal mixers, mills, calendars and extruders, for example. The apparatus could also be used in domestic as well as industrial applications.

The invention has application across all industries where mixing is required. Examples of industries in which the apparatus of the present invention can be applied are bulk chemicals, fine chemicals, petro chemicals, agro chemicals, food, drink, pharmaceuticals, healthcare products, personal care products, industrial and domestic care products, packaging, paints, polymers, recycling, water and waste treatment.

1. A mixing apparatus comprising: an elongate annular mixing chamber defined around a longitudinal axis and having a radial width defined between facing surfaces of a first elongate mixing member disposed axially within a second tubular mixing member; the first and second mixing members being relatively rotatable; an inlet for introducing material to be mixed into the mixing chamber, and an outlet for removing material from the mixing chamber, wherein for any given rotational position of the first and second mixing members the radial width of at least one axially extending portion of the mixing chamber varies around the axis to define at least one radial constriction; the radial constriction extending along the length of said portion of the mixing chamber in a direction subtending an angle no greater than 45° to any plane containing said axis.

2. A mixing apparatus according to claim 1, wherein the inlet is adjacent one axial end of the mixing chamber and the outlet is adjacent the other axial end of the mixing chamber;

3. A mixing apparatus according to claim 1, comprising a pump means for pumping material through the mixing chamber from the inlet to the outlet.

4. A mixing apparatus according to claim 1, wherein said facing surfaces of the first and second mixing members are configured so that when relatively rotated all material within the mixing chamber passes through the or each radial constriction a plurality of times as it flows from the inlet to the outlet.

5. A mixing apparatus according to claim 1, wherein for any cross-section through the mixing chamber on a plane normal to the axis the or each radial constriction has a radial width, the ratio of said radial width to the minimum internal diameter of the second tubular mixing member at that cross-section being at least 0.05.

6. A mixing apparatus according to claim 1, wherein for any cross-section through the mixing chamber on a plane normal to the axis the or each radial constriction has a radial width, the ratio of said radial width to the minimum internal diameter of the second tubular mixing member at that cross-section being on average at least 0.05 along the length of said portion of the mixing chamber.

7. A mixing apparatus according to claim 1, wherein the or each radial constriction extends along the length of said portion of the mixing chamber in a direction substantially parallel to said longitudinal axis.

8. A mixing apparatus according to claim 1, wherein said portion of the mixing chamber comprises the whole length of the mixing chamber defined between the inlet and the outlet.

9. A mixing apparatus according to claim 1, wherein there are at least two of said radial constrictions angularly disposed around the mixing chamber so that for any rotational position of the mixing members radial forces on the mixing members are balanced so that the net force in any radial direction is substantially zero.

10. The apparatus according to claim 9, comprising only two of said radial constrictions defined so that for any rotational position of the mixing members a first radial constriction is diametrically opposed to a second radial constriction.

11. A mixing apparatus according to claim 9, wherein there are two or more radial constrictions defined so that the mixing chamber has rotational symmetry about said axis.

12. A mixing apparatus according to claim 1, wherein the internal surface of the second tubular mixing member has a substantially circular profile along the length of said portion of the mixing chamber, and wherein the outer surface of the first mixing member has a non-circular profile along the length of said portion to thereby define at least in part the or each radial constriction.

13. A mixing apparatus according to claim 1, wherein the inner surface of the second tubular mixing member has a non-circular profile along the length of said portion of the mixing chamber to define at least in part the or each radial constriction.

14. A mixing apparatus according to claim 1, wherein the first elongate mixing member is rotated about said axis within the second tubular mixing member.

15. A mixing apparatus according to claim 14, wherein said second tubular mixing member provides a stationary housing for the mixing chamber.

16. A mixing apparatus according to claim 1, wherein the second tubular mixing member is rotated about said longitudinal axis.

17. A mixing apparatus according to claim 1, wherein said portion of the mixing chamber has a generally cylindrical configuration.

18. A mixing apparatus according to claim 1, wherein said portion of the mixing chamber is generally conical in configuration.

19. A mixing apparatus according to claim 18, wherein the first mixing member and/or second mixing member has a generally conical configuration to define said conically configured mixing chamber.

20. A mixing apparatus according to claim 18, wherein the first and second mixing members are movable axially relative to one another from at least a first position to a second position, such that the radial width of the mixing chamber along the length of the mixing chamber can be varied by said axial movement of the mixing members.

21. A mixing apparatus according to claim 20, wherein the first and second mixing members are axially positionable at a plurality of positions between said first and second axial positions to provide an respective plurality of mixing chamber geometries.

22. Apparatus according to claim 20, wherein the axial position of the first and second mixing members is continuously variable between said first and second positions.

23. A mixing apparatus according to claim 1, wherein the radial width of the or each radial constriction is substantially constant along the length of said portion of the mixing chamber.

24. A mixing apparatus according to claim 1, where in the or each radial constriction is defined by a mixing formation extending from the outer surface of the first mixing member and/or the inner surface of the second mixing member.

25. A mixing apparatus according to claim 24, wherein in cross section in a plane normal to said axis said formation has either straight or curved walls, or a combination of both straight and curved walls.

26. A mixing apparatus according to claim 1, wherein the or each radial constriction of the chamber is defined at least in part by indentations formed in either the outer surface of the first mixing member or inner surface of the second mixing member, the radial constriction being defined between angularly adjacent indentations.

27. A mixing apparatus according to claim 1, comprising a plurality of said mixing chamber portions arranged continuously or discontinuously along said axis.

28. A mixing apparatus according to claim 1, wherein the first elongate mixing member and/or second tubular mixing member have a modular constriction comprising two or more sections arranged end to end.

29. A mixing apparatus according to claim 1, comprising rotation means for rotating either the first mixing member or the second mixing member, or both the first and second mixing members in which case said members are either counter rotated or rotated in the same direction at different speeds.

30. A mixing apparatus according to claim 1, comprising means to axially displace the first and second mixing members relative to one another.

31. A mixing apparatus according to claim 1, wherein at least one of the first and second mixing members is provided with means for cooling or heating the mixing chamber.

32. A mixing apparatus according to claim 31, wherein said cooling or heating means cools or heats the surface of the respective mixing member to thereby cool or heat material within the mixing chamber.

33. A mixing apparatus according to claim 32, wherein said cooling or heating means comprises a one or more passages through a respective mixing member, and means for flowing cooling or heating fluid through the or each passage.

34. A mixing apparatus according to claim 1, wherein said pumping means comprises an extruder.

35. A mixing apparatus according to claim 1, comprising regulating means to regulate the rate of flow and/or the pressure of material passing through the outlet.

36. A mixing apparatus according to claim 1, wherein means are provided for varying the speed or direction of relative rotation of the mixing members.

37. A mixing apparatus according to claim 1, comprising one or more secondary inlets through which material may be added to the mixing chamber at one or more axial locations intermediate said inlet or outlet.

38. A mixing apparatus according to claim 1, comprising one or more secondary inlets positioned for the addition of material to the mixing chamber at one or more intermediate locations on the circumferential boundary of the apparatus.

39. A method of mixing, comprising providing a mixing apparatus comprising: an elongate annular mixing chamber defined around a longitudinal axis and having a radial width defined between facing surfaces of a first elongate mixing member disposed axially within a second tubular mixing member; the first and second mixing members being relatively rotatable; an inlet for introducing material to be mixed into the mixing chamber, and an outlet for removing material from the mixing chamber wherein for any given rotational position of the first and second mixing members the radial width of at least one axially extending portion of the mixing chamber varies around the axis to define at least one radial constriction; the radial constriction extending along the length of said portion of the mixing chamber in a direction subtending an angle no greater than 45° to any plane containing said axis; the method comprising: pumping material to be mixed through said chamber via said inlet and outlet; and relatively rotating said first and second mixing members to cause all material in said mixing chamber to flow through the or each radial restriction a plurality of times.

40. A method according to claim 39, wherein material is pumped through the mixing chamber from the inlet to the outlet.

41. A method according to claim 39, wherein the number of times any part of the material within the mixing chamber passes through the or each radial constriction is regulated by varying the speed of relative rotation of the mixing members and/or the axial rate of flow of material through the mixing chamber.

42. A method according to claim 39, wherein the speed of relative rotation of the first and second mixing members is controlled independently of the axial flow rate of the material through the apparatus, so as to regulate the net amount of mixing energy applied per unit volume of material within the mixing chamber.

43. A method according to claim 39, wherein the speed and/or direction of relative rotation of the first and second mixing members is varied during operation so as to impart varying mixing actions to material within the mixing chamber.

44. A method according to claim 39, wherein the speed and/or direction of relative rotation is varied cyclically with respect to time.

45. A method according to claim 39, wherein the pumping means is controlled to vary the rate of flow of material from the inlet to the outlet cyclically with respect to time.

46. A method of mixing according to claim 39, wherein material is continuously flowed from the inlet to the outlet in a continuous mixing process.

47. A method according to claim 39, wherein the mixing operation is a batch mixing operation.

48. A method according to claim 39, wherein the mixing operation is controlled to generate reaction chemistry conditions required to promote and/or regulate chemical reactions in a particular material within the mixing chamber.

49. A method according to claim 39, wherein the mixing operation is controlled to generate mechanochemical conditions necessary to rupture crosslinks in material present within the mixing chamber.

50. A method according to claim 39, wherein the mixing operation is controlled to apply dispersive and/or distributive mixing to material within the mixing chamber.

51. A method according to claim 39, comprising mixing either a fluid material, solid material, or mixture of fluid and soluble materials.

52. (canceled)

53. (canceled)
